(19) United States
(12) Patent Application Publication
(10) Pub. No.: US 2003/0005997 A1
(43) Pub. Date: Jan. 9, 2003

(54) Composite elastomeric yarns

(76) Inventor: Jeffrey W. Bruner, Greensboro, NC (US)

Correspondence Address: Synnestvedt & Lechner LLP, 2600 Aramark Tower, 1101 Market Street, Philadelphia, PA, 19107, US

(21) Appl. No.: 10/106,863

(22) Filed: Mar. 26, 2002

Related U.S. Application Data
(63) Continuation of application No. 08/775,610, filed on Dec. 31, 1996, now abandoned.

(51) Int. Cl. B32B 31/00

(52) U.S. Cl. 156/166; 297/452.1

(57) ABSTRACT

Disclosed are composite elastomeric yarns comprising a polymeric core, a thermoplastic polymeric sheath disposed about the core and fibers disposed about and mechanically anchored in the sheath. The melting point temperature of the material comprising the sheath is at least about 10° C. and preferably from about 50° C. to about 75° C. lower than the melting point temperature of the material comprising the core. Methods and articles relating to such yarn are also disclosed.

### FIELD OF THE INVENTION

This invention relates to certain composite elastomeric yarns suitable for use in furniture/seating fabrics, methods for making said composite elastomeric yarns and articles incorporating fabrics comprising said composite elastomeric yarns. The composite elastomeric yarns of the present invention are particularly well suited for use in indoor and outdoor furniture fabrics for seats, both bottoms and backs, installed in various forms of ground transportation such as automobiles, motorcycles, trucks, buses, trains, etc., as well as various aircraft and marine craft, where a lightweight combination of strength, comfort and style is desired.

### BACKGROUND OF THE INVENTION

In the past, elastomeric yarns used to produce fabrics having elastomeric properties have typically included rubber and elastomeric polyurethanes, such as spandex, which possess high coefficients of friction. As a result, they are difficult to handle in typical textile yarn and fabric manufacturing processes and are uncomfortable when in direct contact with the human body. Accordingly, it has been necessary to cover, coat or in some other manner conceal the rubber or polyurethanes in the yarn or fabric structure to provide the desired aesthetic, design, comfort, wear and durability characteristics when used in most apparel, home furnishings, medical, automotive, air and marine craft applications, as well as other industrial fabric applications.

In automotive, air and marine craft applications, elastomeric yarns have been incorporated in fabrics used to cover vehicle seats. Vehicle seats found in the various forms of ground, air and marine transportation have often been constructed from varying combinations of bulky polyurethane stuffing material or molded foam cushioning which is then mounted on wire frames or stamped metal pans and covered with fabric. The fabric is typically cut and sewn to size to contain and protect the materials contained within the seat as well as provide a comfortable, durable and attractive finish suitable for the interior design scheme of the vehicle. Depending on the combination of materials chosen, springs or elastic straps are also often used in the seat to provide a vehicle seating assembly with greater static and dynamic support characteristics, as well as passenger comfort. In such seating assemblies, however, the extensive use of foam cushioning, stuffing material and springs or elastic straps adds significantly to the weight of the finished product which is undesired in vehicle applications where fuel economy is often a goal. Further, the use of varying combinations of these separate components results in seat assemblies having higher costs of materials and, because of complicated assembly procedures, greater labor costs as well.

While thin profile seats have been developed, they have not provided the aesthetic qualities that are desired in many furniture fabrics. An example of such thin profile seats is found in Stumpf, et al. (PCT Application No. PCT/US93/05731), which is incorporated herein by reference, wherein an office chair is disclosed.

It is therefore an object of the present invention to provide a composite yarn having elastomeric characteristics.

It is another object of the present invention to provide a composite elastomeric yarn suitable for use in fabrics which offers support and comfort while allowing for significant reduction in the need for foam materials, springs or elastic straps.

It is still another object of the present invention to provide a composite elastomeric yarn which can accommodate a wide variety of surface textures and fiber densities.

It is yet another object of the present invention to provide a method of forming composite elastomeric yarns which are suitable for use in supportive and comfortable fabrics which can accommodate a wide variety of surface textures and fiber densities.

It is still a further object of the present invention to provide a method of forming composite elastomeric yarns which are suitable for use in vehicle seat fabrics.

### SUMMARY OF THE INVENTION

The present invention relates to composite elastomeric yarns, to methods of making same, and to articles in which such yarns are used. The yarns of the present invention comprise a polymeric core, a thermoplastic polymeric sheath disposed about the core, and fibers disposed about and mechanically anchored in the sheath. An important aspect of certain embodiments of the present invention is the requirement that the polymeric core is a thermoplastic polymeric core and that the melting point temperature of the material comprising the sheath is at least about 10° C., and preferably from about 50° C. to about 75° C., lower than the melting point temperature of the material comprising the core.

The method aspects of the present invention comprise the steps of: providing a composite elastomeric yarn comprising a thermoplastic polymeric core and thermoplastic polymeric sheath disposed about the core wherein the melting point temperature of the sheath is at least about 10° C. lower than the melting point temperature of the core; heating the composite elastomeric yarn to a temperature at or above about the melting point temperature of the sheath but below the melting point temperature of the core; disposing fibers in intimate mechanical contact about the sheath; and cooling the composite elastomeric yarn to mechanically anchor said fibers in said sheath. In certain preferred embodiments, the methods further comprise stretching the composite elastomeric yarn from about 10% to about 500% beyond the relaxed state prior to the step of disposing said fibers. This preferred method enhances the ability of the manufacturer to vary the fiber density and/or bulk of the resulting composite yarn.

The articles of the present invention relate to furniture fabrics, and particularly to seating fabrics, comprising composite elastomeric yarns for use in seats and backs of chairs, benches and sofas used in office and/or residential environments or installed in various forms of ground transportation such as automobiles, motorcycles, trucks, buses, trains, etc. as well as various aircraft and marine craft. By using fabrics comprising the composite elastomeric yarns in vehicle seating assemblies, a fabric possessing strength, comfort and elasticity can be achieved in combination with superior aesthetic qualities. In certain preferred embodiments, thin profile vehicle seating assemblies can be constructed with fabrics comprising the composite elastomeric yarns without the need for bulky foam cushions, stuffing material, springs or rubber straps while maintaining a desirable combination of support, comfort and appearance.

### BRIEF DESCRIPTION OF THE DRAWINGS

FIG. 1 is a partially cross-sectional, partially angled view of a composite elastomeric yarn according to a first embodiment of the present invention.

FIG. 2 is partially cross-sectional, partially angled view of a second embodiment of the present invention having a multifilament core.

FIG. 3 is the first view in a sequence of profile views showing a segment of the interior yarn prior to the disposition of fibers on the surface of the sheath.

FIG. 4 is the second view in a sequence of profile views showing the disposition of fibers on the surface of the sheath of the segment of FIG. 3 after the interior yarn has been stretched.

FIG. 5 is the third view in a sequence of profile views showing the segment of FIG. 3 after the composite yarn has been relaxed from a stretched state in which fibers have been disposed on and anchored to the surface of the sheath.

### DETAILED DESCRIPTION OF THE PREFERRED EMBODIMENTS

### The Yarns

As disclosed herein, the preferred composite yarns of the present invention have improved properties both in high elongation/low modulus embodiments as well as low elongation/high modulus embodiments. More specifically, the composite yarns of the present invention provide an aesthetically pleasing outer surface in both elongated and relaxed form, improved adherence of surface fibers to the elastomeric core, and improved abrasion resistance. Further, the preferred composite yarns of the present invention are able to lock in and hide electro-conductive yarns in the interior as well as cover flammable elastomers with non-flammable or fire resistant fibers to produce elastic yarns which will not burn or propagate flame spread.

From an aesthetic perspective, composite yarns of the present invention can be produced with varying degrees of bulk and varying moduli depending on the desired application, and can be brushed in yarn or fabric form resulting in minimal fiber loss as the surface fibers are mechanically anchored into the yarn core. When used in fabrics for vehicle seats in automotive, air and marine craft applications, the combination of properties of the yarns of the present invention provides the necessary support, comfort and appearance previously achieved by means of the combination of foam cushioning, stuffing material, springs, and elastic straps.

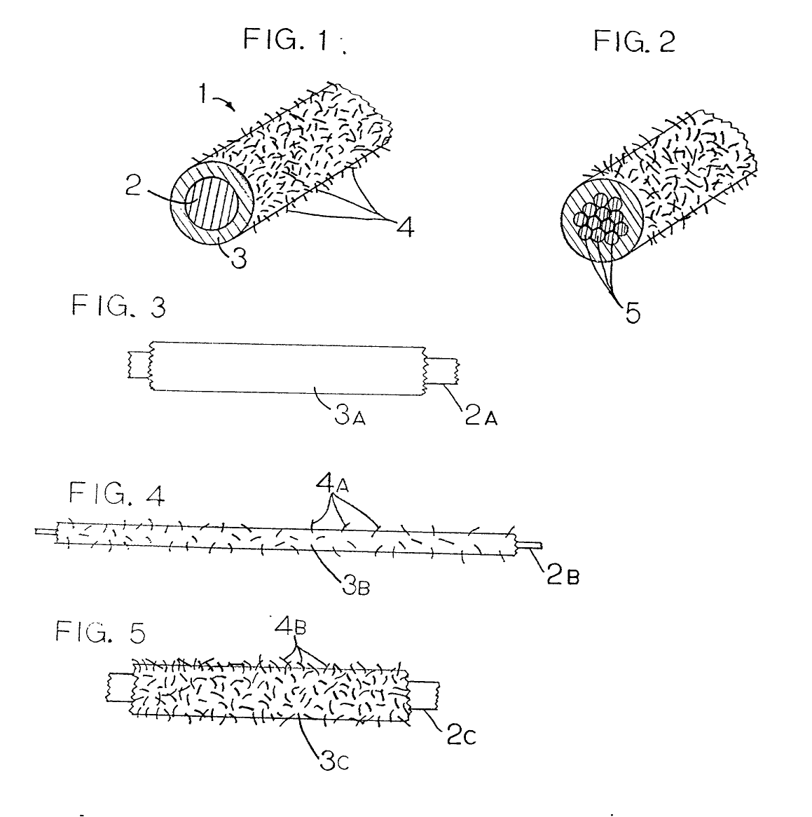

The composite yarns of the present invention preferably comprise a thermoplastic polymeric core, a thermoplastic polymeric sheath disposed about the core, and fibers disposed about and mechanically anchored in the sheath. FIG. 1 shows generally a segment of a preferred composite yarn of the present invention 1. As further shown in FIG. 1, the yarns comprise a core 2, a sheath 3, and fibers 4 disposed about and mechanically anchored into the sheath. Although the anchored fibers are illustrated in the figures as short, individual strands of fibers, it should be appreciated that in certain embodiments the “fibers” may be part of or incorporated into a yarn disposed about the sheath. In certain embodiments, the core component of the interior yarn comprises a thermoplastic polymeric monofilament, while in other embodiments, as shown in FIG. 2, the core comprises a plurality of thermoplastic polymeric filaments 5 which can be configured in a number of alternative forms well known to the art (i.e., bundled, twisted, braided, etc.).

The interior yarn of the present invention preferably comprises a core component and a sheath component. As stated above, in certain embodiments the core component comprises a monofilament while in other embodiments the core component comprises a plurality of filaments. The polymeric material comprising the core, whether in a monofilament or multifilament embodiment, preferably comprises a polymer which exhibits a relatively high melting point temperature. It is preferred that the melting point temperature of the material comprising the core be in the range of from about 185° C. to about 240° C., and preferably from about 200° C. to about 230° C. By comparison, the polymeric material comprising the sheath component of the interior yarn preferably comprises a polymer which exhibits a melting point temperature at least 10° C. lower than the melting point temperature of the core material. It is preferred that the melting point temperature of the material comprising the sheath be in the range of from about 100° C. to about 200° C., and preferably from about 160° C. to about 190° C.

Provided that the relative melting points of the core material and the sheath material differ by at least about 10° C., the materials comprising the core and the sheath can be selected from a wide variety of readily available polymers which exhibit thermoplastic properties. It is preferred, however, that the melting point temperature differential between the materials comprising the core and the sheath be from up to about 50° C. to up to about 75° C. to allow for greater flexibility in subsequent manufacturing processes. By using materials having different melting points, the sheath component of the interior yarn can be heated to a temperature which results in at least the softening and/or tackifying of the sheath material while the core component of the interior yarn remains in substantially solid and oriented form.

For high modulus/low elongation yarns, the hardness of the core component of the interior yarn of the present invention, as measured on the Shore D hardness scale, is preferably from about 38 to about 82, more preferably from about 45 to about 72, and even more preferably from about 55 to about 63. Although it is contemplated that numerous polymers may be used as the core component of the present invention, thermoplastic polymers which exhibit elastomeric properties are preferred, with elastomeric polyesters being especially preferred. It will be appreciated by those skilled in the art that the term “polyester” as used herein is intended to include polymers which include polyester components, such as co-polymers of polyesters and other polymeric components, including graft and block co-polymers. In certain preferred embodiments, the core component comprises the polyester block co-polymer sold under the trademark HYTREL® by E.I. Du Pont de Nemours & Co., Inc., and even more preferably, HYTREL® grade 55556 or 6356. According to preferred embodiments, the core component consists essentially of polyester, and preferably polyester selected from the group consisting of polyether esters and polyester esters, examples of which are HYTREL® and the product sold under the trademark ARNITEL® by D.S.M. Polymers.

According to preferred embodiments, the interior yarn preferably comprises a core having a hardness of about 55 to about 63 on the Shore D hardness scale and comprising a co-polyester elastomer, and a sheath of a softer, lower melting point elastomer of having a hardness of about 35 to about 45 on the Shore D hardness scale.

The percent elongation of the core at the breaking point is preferably from about 50% to about 150% beyond its relaxed state, more preferably from about 80% to about 130% beyond its relaxed state, and even more preferably from about 100% to about 110% beyond its relaxed state. The denier range of the core component of the interior yarn of the present invention is preferably from about 500 to about 2500 and even more preferably from about 800 to about 2000.

The material comprising the sheath component of the interior yarn of the present invention is preferably compatible with the material comprising the core component in order to establish appropriate bonding to and adherence with the core component. The hardness of the sheath component of the interior yarn of the present invention, as measured on the Shore D hardness scale, is preferably from about 30 to about 40.

In certain preferred embodiments, additives can be included in the polymeric material used to form the interior yarn in order to enhance various properties desired for specific end use requirements. Such additives include, but are not limited to, hydrolytic stabilizers, UV light stabilizers, heat stabilizers, color additives and fixing agents, flame retardants, as well as electrically conductive materials for dissipation of static charges.

The fibers 4 which are disposed about the surface of the sheath as shown in FIG. 1 generally comprise conventional non-elastic materials which are often used in apparel, home furnishings, automotive, aircraft and marine applications, as well as other industrial and medical applications. It will be appreciated by those skilled in the art that the fibers 4 which may be utilized in accordance with the present invention can vary widely depending on the particular characteristics desired for the end product. Furthermore, as mentioned above, the fibers may be single, individual fibers, such as chopped strand, or fibers which are spun, twisted or otherwise bound together to form a yarn. The fibers of the present invention are preferably selected from the group consisting of cotton, carbon, wool, man-made cellulosics (including cellulose acetate and regenerated cellulose), polyamide, polyester, fluorocarbon polymers, polybenzimidazole, polyolefins (including polyethylene and polypropylene), polysulfide, polyacrylonitriles, polymetaphenylene isophthalamide (such as NOMEX®), polyvinyl acetate, polyvinyl chloride, polyvinylidene chloride and other flaccid textile materials, as well as non-flaccid fibers such as aramids (KEVLAR® and NOMEX® manufactured by E.I. Du Pont de Nemours & Co., Inc.), fiberglass, metallic and ultra high strength polyethylenes and high tenacity polyesters, nylons and poly(vinyl alcohols). These fibers can also be characterized by type, i.e., spun (ring, friction and wrap), chenille, and filament (flat, false twist, airjet, stuffer box, etc.). It will be understood that as used herein fibers can include both fibers in free form as well as fibers which already comprise yarns.

The exterior yarn is preferably disposed about the surface of the interior yarn by means of the various methods set forth below wherein the fibers of the exterior yarn are anchored in the interior yarn. So disposed, the interior yarn and the exterior yarn are mechanically bonded together so that the resulting composite elastomeric yarn exhibits durability and wear resistance while also providing a wide range of textures and fiber densities depending on the fibers used and the particular method of application employed.

### The Methods

The methods of the present invention relate to the formation of composite elastomeric yarns. The methods preferably comprise the steps of: providing a composite elastomeric yarn comprising a thermoplastic polymeric core and a thermoplastic polymeric sheath disposed about the core wherein the melting point temperature of the sheath is at least about 10° C. lower than the melting point temperature of the core; heating the composite elastomeric yarn to a temperature above the melting point of the sheath but below the melting point of the core; disposing fibers in intimate mechanical contact about the sheath; and cooling the composite elastomeric yarn to mechanically anchor the fibers to the sheath.

The above description in which the heating step is described prior to the cooling step should not be understood as limiting the sequence of the steps used according to the present invention. According to preferred embodiments, for example, the step of disposing the fibers in intimate contact with the sheath occurs prior to heating of the composite elastomeric yarn.

In certain preferred embodiments, as shown in the sequence of FIG. 3 to FIG. 5, the composite elastomeric yarn will be stretched from about 10% to about 500% beyond its relaxed length prior to the disposition of fibers about the sheath.

The initial step of providing the interior yarn, also referred to herein as the sheath-core component, can be accomplished in a variety of ways including forming the sheath-core component by methods well known to the art or obtaining certain pre-made interior yarns from other sources. The methods of forming the sheath-core component include the pulltrusion technique of forming the core component and then drawing the core component through a molten bath of the sheath material at a temperature above that of the melting point temperature of the sheath material but below that of the melting point temperature of the core material. Alternatively, the core component can be simultaneously co-extruded with the sheath component at a temperature appropriate for such simultaneous co-extrusion in a manner such that the extrudate comprises a core comprising the higher melting point material and a sheath comprising the lower melting point material as disclosed by Himmelreich, Jr. (U.S. Pat No. 4,469,738) which is incorporated herein by reference. Another alternative for providing an interior yarn according to the present invention is a crosshead technique in which the core of the interior yarn is preformed and is fed through the center of a crosshead extrusion die wherein the sheath material is extruded as an outer jacket or covering over the preformed core material. It will be understood that certain embodiments of the methods of the present invention will employ a monofilament core, while in other embodiments of the methods of the present invention the core comprises a plurality of filaments.

Another step in the methods of the present invention comprises heating the interior yarn to a temperature above that of the melting point temperature of the sheath material but below that of the melting point temperature of the core material. In so doing, the sheath material is softened or at least tackified to permit mechanical bonding with the fibers subsequently applied. In certain preferred embodiments, the heating will occur during manufacture of the composite yarn but prior to incorporation of the yarn into a fabric. In other embodiments, however, the partially-formed yarn of the present invention is first incorporated into a fabric manufacturing process so that the resulting fabric comprising the yarn of the present invention will be the article that is heated.

In certain preferred embodiments, the heated interior yarn is stretched beyond its relaxed state but within its elastic range prior to the application of fibers as shown in the sequence of FIG. 3 to FIG. 5. Such stretching allows the resulting composite yarn to take on varying degrees of bulk and/or density. More specifically, FIG. 3 shows a segment of the interior yarn comprising a core 2A and sheath 3A prior to stretching. FIG. 4 shows the subsequent view of the segment shown in FIG. 3 in which the segment of the interior yarn has been stretched and fibers 4A have been disposed about the surface of sheath 3B. Sheath 3B and core 2B are shown having a thinner profile as a result of the stretched state depicted in FIG. 4. FIG. 5 shows a view subsequent to the view shown in FIG. 4 in which core 2C and sheath 3C have returned to their original relaxed, i.e. unstretched, state, and fibers 4B exhibit a greater density than fibers 4A exhibit in FIG. 4. As shown by the sequence of FIGS. 3 to 5, when the interior yarn is stretched, any given interval of the interior yarn in the relaxed form presents a greater surface area in stretched form on which to accommodate the application of fibers. Thus, when the composite yarn is then relaxed to an unstretched state, the density of fibers within any given interval is greater than if such fibers were applied without stretching. As a result, the greater degree to which the interior yarn is stretched prior to the application of fibers, the greater the bulk in the resulting composite fiber.

In certain preferred embodiments, the methods of the present invention further comprise the step of stretching the interior yarn from about 10% to about 500% beyond its relaxed length prior to the application of fibers. The optimal degree of stretching will depend upon the materials used in forming the interior yarn as well as the intended end use of the composite yarn. By way of example, for high modulus thermoplastic polyether-ester block copolymer elastomers such as HYTREL®, the degree of stretching beyond its relaxed length would be from about 10% to about 40%, and preferably from about 12% to about 18%. For lower modulus elastomers such as LYCRA® spandex manufactured by E.I. Du Pont de Nemours & Co., Inc., the degree of stretching would typically be from about 300% to about 500%, and preferably from about 350% to about 425%. In certain preferred embodiments, by stretching the interior yarn prior to application of the fibers, the resulting composite yarn when used in fabric manufacturing processes (i.e., weaving, knitting, etc.) will be able to stretch and recover freely without significant restrictions imposed by the fibers anchored in the composite yarn surface. It will be understood that, depending on the desired manufacturing process and end use, for those embodiments in which a stretching step is a part, the stretching step can occur when the interior yarn is in yarn form or when it has already been processed or partially processed into a fabric.

Another step in the methods of the present invention comprises disposing fibers in intimate mechanical contact about the heated interior yarn. As stated above, in certain preferred embodiments, the disposition of fibers will occur while the interior yarn is in yarn form. In other embodiments, however, the interior yarn will have already been used in a fabric manufacturing process so that the application of fibers will be upon the surface or surfaces of the fabric. It will be understood that the fibers disposed about the interior yarn can be in the form of free fibers or in the form of yarn or a combination thereof. Depending on the fibers to be applied, the desired bulkiness, and the desired end use, the form of the fibers so disposed will vary and the process by which the fibers may be disposed includes wrapping, spinning, twisting, flocking, or any number of other procedures well known to the art provided, however, that by so disposing the fibers about the interior yarn said fibers are able to penetrate into at least the sheath component of the interior yarn so as to achieve a mechanical bond thereto.

The heating/bonding step for locking the exterior textile fibers to the interior yarn preferably takes place directly after the disposition of the fibers around the interior sheath/core yarn, and preferably, just before the completed composite yarn is wound on its supply package. Alternatively, the heating/bonding can take place in fabric form as well or by heating the interior sheath/core yarn prior to the disposition of exterior textile fibers.

The final step in the methods of the present invention comprises cooling the composite elastomeric yarn so as to effect the anchoring of the fibers to the interior yarn.

### The Articles

The resulting composite elastomeric yarns of the present invention can be used in fabric manufacturing processes for the formation of fabric articles having a desirable combination of properties well suited for use in vehicle seats in automotive, air and marine craft applications. Because of the superior elasticity, durability and wear resistance of fabrics made from composite elastomeric yarns of the present invention, as well as the wide range of textures and fiber densities which can be achieved, vehicle seats for use in automotive, air and marine craft applications can be constructed without the need for the additional use of foam cushioning, stuffing material, springs, elastic straps or combinations thereof. Such thin profile vehicle seats as described in Abu-Isa, et al. (U.S. Pat. No. 5,013,089), Abu-Isa, et al. (U.S. Pat. No. 4,869,554) and Abu-Isa, et al. (U.S. Pat. No. 4,545,614) all of which are incorporated herein by reference, are examples of preferred articles which can be constructed from fabrics comprising composite elastomeric yarns of the present invention.

What is claimed is:

1. A composite elastomeric yarn comprising:
a thermoplastic polymeric core;
a thermoplastic polymeric sheath disposed about the core wherein the melting point temperature of the sheath is at least about 10° C. lower than the melting point temperature of the core; and
fibers mechanically anchored in and disposed about the sheath.

2. The yarn of claim 1 wherein the core comprises a monofilament.

3. The yarn of claim 1 wherein the core comprises a plurality of filaments.

4. The yarn of claim 1 wherein said fibers comprise flaccid textile materials.

5. The yarn of claim 1 wherein said fibers comprise non-flaccid fibers.

6. The yarn of claim 1 wherein the fibers are selected from the group consisting of cotton, carbon, wool, man-made cellulosics, polyamide, polyester, fluorocarbon polymers, polybenzimidazole, polyolefins, polysulfide, polyacrylonitriles, polymetaphenylene isophthalamide, polyvinyl acetate, polyvinyl chloride, polyvinylidene chloride, fiberglass, poly(vinyl alcohols) and combinations of two or more of these.

7. The yarn of claim 1 wherein the fibers are physically bonded to the sheath by means of heating the sheath to a temperature above the melting point temperature of the sheath but below the melting point temperature of the core.

8. The yarn of claim 1 wherein the melting point temperature of the sheath is from about 50° C. to about 75° C. lower than the melting point temperature of the core.

9. A process of forming a composite elastomeric yarn comprising the steps of:
providing a sheath-core component comprising a thermoplastic polymeric core and a thermoplastic polymeric sheath disposed about the core wherein the melting point temperature of the sheath is at least about 10° C. lower than the melting point temperature of the core;
heating the sheath-core component to a temperature to at least soften the sheath but below the melting point temperature of the core;
disposing fibers in intimate mechanical contact about the sheath; and
cooling the composite elastomeric yarn to anchor the fibers in the sheath.

10. The process of claim 9 wherein said disposing step preceeds said heating step.

11. The process of claim 9 wherein the core comprises a monofilament.

12. The process of claim 9 wherein the core comprises a plurality of filaments.

13. The process of claim 9 wherein the sheath-core component is stretched from about 10% to about 500% beyond its relaxed length prior to the disposition of fibers about the sheath.

14. The process of claim 9 wherein the fibers are selected from the group consisting of cotton, carbon, wool, man-made cellulosics, polyamide, polyester, fluorocarbon polymers, polybenzimidazole, polyolefins, polysulfide, polyacrylonitriles, polymetaphenylene isophthalamide, polyvinyl acetate, polyvinyl chloride, polyvinylidene chloride, fiberglass, poly(vinyl alcohols) and combinations of two or more of these.

15. The process of claim 9 wherein the melting point temperature of the sheath is from about 50° C. to about 75° C. lower than the melting point temperature of the core.

16. A seat assembly, having a seat frame and a low profile seat suspension stretched across and attached to the frame, the improvement being that said seat suspension comprises a fabric comprising composite elastomeric yarn wherein said composite elastomeric yarn comprises a thermoplastic polymeric core, a thermoplastic polymeric sheath disposed about the core wherein the melting point temperature of the sheath is at least about 10° C. lower than the melting point temperature of the core, and fibers mechanically anchored in and disposed about the sheath.

17. The seat assembly of claim 16 wherein the seat assembly is installed in a land, sea or air vehicle.

18. Commercial indoor furniture comprising the seat assembly of claim 16.

19. Commercial outdoor furniture comprising the seat assembly of claim 16.

20. Residential indoor furniture comprising the seat assembly of claim 16.

21. Residential outdoor furniture comprising the seat assembly of claim 16.
